(19) United States
(12) Patent Application Publication
(10) Pub. No.: US 2013/0088866 A1
(43) Pub. Date: Apr. 11, 2013

(54) LED STREET LIGHT

(71) Applicant: Mark Anthony Stroud, London (CA)

(72) Inventor: Mark Anthony Stroud, London (CA)

(73) Assignee: VIALUMINARY LTD., London, ON (CA)

(21) Appl. No.: 13/805,047

(22) PCT Filed: Jun. 18, 2010
(86) PCT No.: PCT/CA2010/000956

§ 371 Date: Dec. 18, 2012

(51) Int. Cl. F21V 29/00; F21V 5/04

(52) U.S. Cl. CPC F21V 29/004; F21V 5/04
USPC 362/235; 362/294; 362/382

(57) ABSTRACT

A one piece heat sink LED platform body for a streetlight with an integrally formed hemispherical protuberance, a LED cluster, a lens cover, a LED driver, an array of cooling fins, and a fiber optic cable.

### FIELD OF THE INVENTION

The present invention relates to street lighting. In particular, the invention relates to street lights using a LED light source as compared to the traditional prior art incandescent or high pressure sodium lights.

A benefit of LED lighting is a significant reduction in power use for an equivalent light output resulting in significant cost savings. The LED uses a direct current power supply eliminating the high frequency flicker of alternating current driven incandescent lighting. A further benefit of LED lighting is the longer life expectancy compared to incandescent bulbs resulting in additional cost savings. Furthermore, LED lighting does not fail catastrophically. The end of life for an LED light is signalled by a gradual degradation of light giving advance warning of failure.

The use of LEDs in clusters of emitters will produce the amount and type of light suitable for street lighting. Notwithstanding that the heat generated by individual LED emitters is low, in a cluster configuration heat build up is a technical factor that needs to be addressed to avoid premature failure. One approach according to this invention is to mount the LED cluster on a heat sink for heat dissipation. The longer life expectancy for LED lighting is optimally realizable if the junction temperature of the LED can be kept well below the LED's maximum operating temperature.

A preferred exemplary device incorporating the concepts of the present invention is shown by way of example in the accompanying drawings without attempting to show all the various forms and modifications in which the invention might be embodied, the invention being measured by the appended claims and not by the details of the specification.

### SUMMARY OF THE INVENTION

According to one aspect of the invention, a heat sink LED platform body for a street light is provided having an LED driver mounted on the rear surface. An integrally formed hemispherical protuberance is integrally formed on the front surface and an open cavity is formed therein. An LED light source is mounted within the cavity and electrically connected to the LED driver. An array of integrally formed cooling fins is formed on the front surface of the platform.

According to another aspect of the invention, the protuberance is centrally located on the front face of the LED platform body.

According to another aspect of the invention, a material having high thermal conductivity is used for the platform, such as aluminum.

According yet to another aspect of the invention, an LED light cluster is used as the light source.

According to yet another aspect of the invention, the outside dimensions of the platform are standardized with respect to a standardized street light fixture so that the platform may be adapted to be fitted or retrofitted therein for operational use.

According yet to another aspect of the invention, an ambient light detecting fiber optic cable is operatively connected to the LED driver and controls the amount of electrical power being delivered to the LED light source as a function of ambient light conditions.

### DESCRIPTION OF THE DRAWINGS

In order that the invention may be more clearly understood, a preferred embodiment thereof will now be described in detail by way of example, with reference to the accompanying drawings, in which:

FIG. 1 is an angled view of the heat sink for a light fixture.

FIG. 2 is an exploded side view illustration of the heat sink for a light fixture.

FIG. 3 is a top view illustration of a heat sink for a light fixture according to the present invention.

FIG. 4 is a preferred embodiment of a heat sink installed for a street light fixture according to the present invention.

### DESCRIPTION OF THE PREFERRED EMBODIMENTS

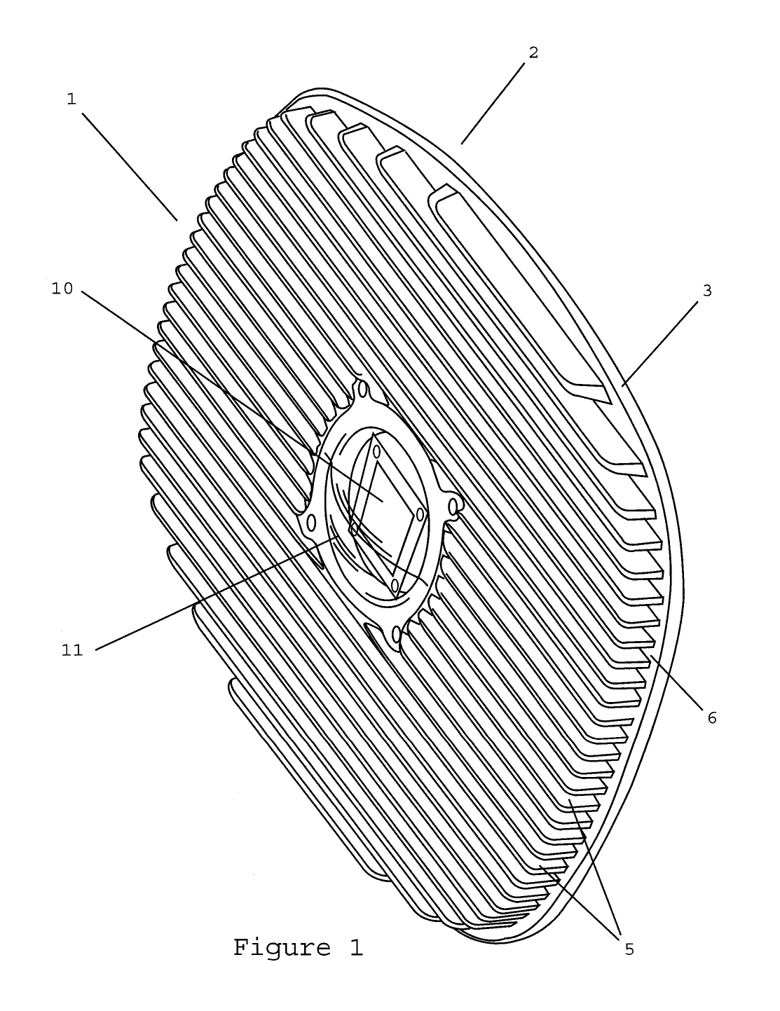

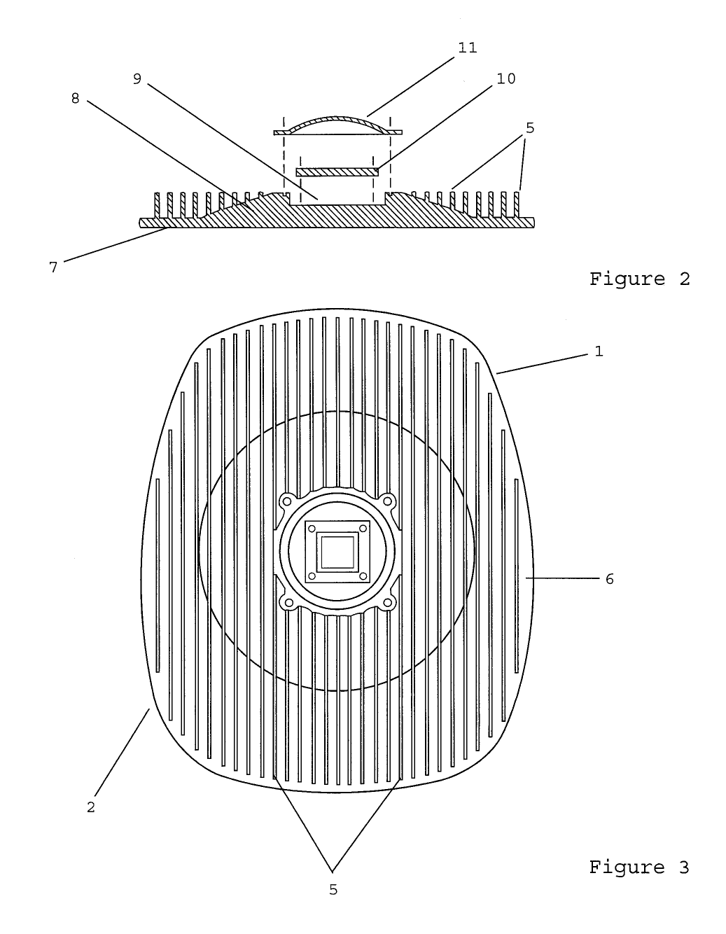

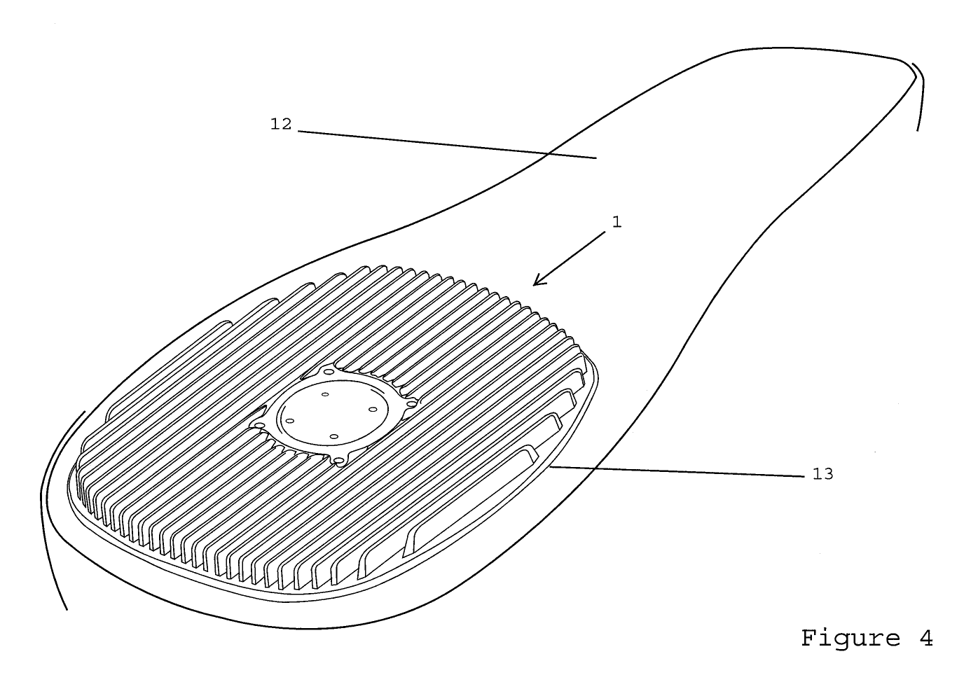

Referring to FIG. 1, a heat sink LED platform body 1 is shown having a perimeter shape 2 and thickness 3 suitable for installation within a standardized street light fixture.

The platform has a front surface which features cooling fins 5 which will be hereinafter described. The peripheral edges of the cooling fins 5 are located inward of the outside perimeter of the platform body 1 thereby forming a lap shaped edge 6. The outside perimeter of the platform is dimensionally wider than the standardized light fixture aperture and shaped identically thereto. This enables the lap edged platform to be seated in the fixture aperture and secured therein by conventional means with the front finned surface protruding there-through.

The platform has a flat back surface 7 which functions as a mounting surface for an electronic power supply or LED driver (not shown) used to power the LED light source.

The platform body 1 has a uniform thickness 3 and an integrally formed, centrally located raised mass portion 8. The raised mass portion 8 is a circularly shaped hemispherical protuberance that tapers downwardly and merges with the body of the platform.

A cavity 9 is formed within the hemispherical protuberance for mounting an LED light source 10 which is conventionally secured therein and electrically connected to the power supply by means of a channel communicating with the back surface. A lens 11 overlies the LED module cavity and is conventionally secured to the platform body 1.

The remaining front surface of the body 1 is provided with a spaced apart cooling fin array 5 to facilitate heat transfer away from the platform.

It has been found that the raised mass portion 8 surrounding the LED light source improves the heat transfer away from the platform at the point of greatest heat generation. The localized raised mass portion 8 allows for more efficient heat transfer. As well, less platform body 1 material is used overall.

In the preferred embodiment, the platform is oval shaped having approximate outside dimensions of 11.5 by 13.5 inches and may be used in combination with a 50 W or 100 W LED module, such as by way of example, the EdiStar Series made by Opto Edison. The platform body thickness 3 is preferably ¼ inches. The centrally located raised mass portion 8 preferably has a diameter of 8 inches and a maximum height of preferably ⅝ inches having a mass of approximately 15 to 16 cubic inches. The foregoing platform proved useful in maintaining the temperature of the LED cluster optimally below 165 degree Fahrenheit for the 100 W LED cluster and optimally below 172 degree Fahrenheit for the 50 W LED cluster.

The use of cooling fins 5 is well known. It is to be noted that increasing power of the LED light source 10 may require the increase of the surface area of the cooling fins 5. The radiating surface area may be enlarged by making the fins thinner and thereby increasing the surface to mass ratio. Preferably, the fins 5 have a width of 3/38 inches and a standardized height of 6/5 inches and are spaced ¼ inches apart.

These dimensions were found to be effective in maintaining the LED cluster at a temperature below approximately 172 degree Fahrenheit for a 50 Watt light cluster and approximately 165 degree Fahrenheit for a 100 Watt light cluster.

It is to be particularly noted that the platform according to the present invention may be used to easily retrofit existing light fixtures 12 operating with high density sodium light by removal of the light and installation of the platform. The invention may be retrofitted on existing street light installations by removing the existing glass globe, incandescent light component and aluminum reflector. The one piece heat sink platform 1 is then placed in the aperture 13 opening left by the removal of the existing glass globe. The LED driver is plugged into the fixture power supply. The platform 1 has an approximate total weight of 10 lbs, which is lighter than existing street light components. It can be designed to the corresponding aperture size of existing light housing 12 for easy and quick installation.

The platform material is preferably selected from metals or allows having a high thermal conductivity. In the preferred embodiment, aluminum alloy 6061 T6 is used.

An additional feature of the present invention is the use of the specialized lens 11 for the LED light cluster that emits a type 3 light pattern which concentrates the emitted light to less than 180 degrees in a downward direction thereby reducing light pollution.

In another embodiment, the platform 1 may be equipped with a fibre optic cable (not shown) which is integrated into the LED driver. The fibre optic cable is exposed at one end to capture ambient light and functions to control the amount of electrical input to the LED light source. In other words, the light output of the LED light source becomes a function of ambient light. As ambient conditions darken, the driver will be electrically signalled to deliver more power to the LED light source thereby turning on and progressively increasing the light output by the LED light source. The fibre optic cable can replace existing photoelectric eyes that operate only in an on-off position. Use of the fibre optic cable would generate additional energy savings. When an outside switch is desired or preferred, the fibre optic cable feature can be stored interior of the light fixture and relinquish control of the light output to the outside switch.

Further advantages which are inherent to the invention are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

What is claimed:

1. A heatsink LED platform body for a streetlight having a thickness, outside dimensions, a rear surface, and a front surface, said platform having:
a. a LED driver mounted on the rear surface;
b. an integrally formed hemispherical protuberance on the front surface;
c. an open cavity formed in said protuberance;
d. a LED light source mounted within said cavity and electrically connected to said LED driver;
e. a lens cover mounted on said cavity; and
f. an array of integrally formed cooling fins on the front surface thereof.

2. The platform of claim 1, wherein said protuberance is centrally located.

3. The platform of claim 1, wherein said body is made of a material having high thermal conductivity.

4. The platform of claim 3, wherein said material is aluminum.

5. The platform of claim 4, wherein said aluminum is alloy 6061 T6.

6. The platform of claim 4, wherein said light source is a LED light cluster.

7. The platform of claim 6, wherein said LED light cluster is either a 50 W or a 100 W EdiStar Series LED module.

8. The platform of claim 7, wherein said lens is a type 3 light distribution pattern.

9. The platform of claim 8, wherein said body has outside dimension that are standardized and made referable to a standardized street light fixture and the platform body is thereby adapted to be fitted therein for operational use.

10. A heatsink LED platform body having a thickness, outside dimensions, a rear surface, and a front surface, said body having:
a. an integrally formed hemispherical protuberance centrally located on the front surface;
b. an open cavity formed with said protuberance ;
c. and an array of integrally formed cooling fins.

11. A heatsink LED platform body of claim 1, for installation into standardized streetlight housing.

12. The platform of claim 1, wherein an ambient light detecting fiber optic cable is operatively connected to the LED driver to thereby control the amount of electrical power being delivered to the LED light source as a function of ambient light conditions.
